(19) United States
(12) Patent Application Publication
(10) Pub. No.: US 2004/0007803 A1
(43) Pub. Date: Jan. 15, 2004

(54) Angle clamp with Z-axis attachment and quick acting buttons

(76) Inventor: Harry Wong, South Pasadena, CA (US)

Correspondence Address: PAUL WANG, 7141 PARAMOUNT BLVD., PICO RIVERA, CA, 90660, US

(21) Appl. No.: 10/610,688

(22) Filed: Jul. 1, 2003

Related U.S. Application Data
(60) Provisional application No. 60/393,874, filed on Jul. 8, 2002.

(51) Int. Cl. B25B 1/20

(52) U.S. Cl. 269/41

(57) ABSTRACT

A clamping device allows welding, or other application of three-axis workpieces by providing X, Y, and Z clamping surfaces. The device is equipped with three mutually perpendicular base plates and on one of which a floating right-angle head is mounted through a threaded shaft with quick acting button for rapid advance and return. Inserts like leveling pads can be inserted to the tooling holes in the floating right-angle head to increase working access, especially at the joint area where the X and Y axes meet. A Z-axis attachment including base plate extension with clamping arm and a threaded shaft is mounted by screws to two of the base plates. The clamping arm of the Z-axis can be swung away for easy removal of the workpiece after work. The outside walls of the base plates are machined flat and square so that the angle clamp can be laid sideway to hold a workpiece vertically in place.

Note: This application is based on my provisional patent application filed on Jul. 8, 2002 with application Serial No. 60/393,874.

### REFERENCE

### U.S. PATENT DOCUMENTS

U.S. Pat. No. 788,716 filed May 1905 R. A. Hammond & F. E. Walden

U.S. Pat. No. 2,430,458 filed November 1947 Leo E. Farrell

U.S. Pat. No. 3,492,886 filed February 1970 E. M. Naureckas

U.S. Pat. No. 4,789,146 filed December 1988 Andrew Kuei

U.S. Pat. No. 5,897,109 filed April 1999 Kuo-chuan Lin

### BACKGROUND OF THE INVENTION

1. Field of the Invention

The present invention relates to an improved clamping device which can be used to hold workpieces in a three dimensional 90-degree relationship with the addition of the Z-axis attachment. And the workpieces can easily be removed after work by pressing the quick acting buttons to release the threaded shafts mounted with the clamping heads. The swing away clamping arm of the Z-axis attachment gives even more room for easier removal of the workpieces if necessary.

2. Description of the Related Art

A typical clamp (or vise) generally includes a fixed head (or jaw) and a movable head (or movable jaw) attached to one end of a threaded shaft. Clamping action is achieved by turning the threaded shaft so that the movable head is moved towards the fixed head against the workpiece. By turning the threaded shaft counterclockwise, the movable head is moved away from the fixed head and hence the workpiece is released. With such a device, a workpiece is clamped in one direction, or one dimensional. To clamp workpieces in two or three different directions, two or three such devices have to be used and fixed to a specially constructed fixture which provides the multi-dimensional relationship of the workpieces. However, the setup of this fixture is time-consuming and sometimes inconvenient.

Furthermore, the movable heads have to be moved in or out individually by turning the corresponding threaded shaft clockwise or counterclockwise to adjust for different sizes of workpieces. This is another time-consuming process.

The present invention is intended to simplify the procedures and minimize the time consumed in clamping the workpieces in a three-dimensional mutually perpendicular relationship and in releasing the assembled workpieces after work.

### BRIEF SUMMARY OF THE INVENTION

An angle clamp in accordance with the present invention comprises three mutually perpendicular base plates, one square shape bottom-plate and two smaller rectangular side-plates. The bottom-plate includes two slotted holes along two adjacent edges which are not connected to the side-plates, one along each edge, so that the angle clamp can be fixed to a work desk with two screws. The bottom-plate is equipped with a protruded ear at the vertex away from the side-plates. The ear is positioned to face the opposite vertex. A quick release mechanism with quick acting button and half-threaded nut is mounted in the notch of the ear so that it is free to rotate about its vertical axis. A threaded shaft is inserted through the half-threaded nut in the direction of the diagonal of the bottom-plate. The threaded shaft can be swung horizontally with the half-threaded nut in various directions other than 45 degrees to the edges of the bottom-plate. Attached to the outside end of the threaded shaft is a handle for turning the threaded shaft inward or outward to clamp or release the workpieces. A right-angle head is mounted to the inside end of the threaded shaft through a pivoted block so that the right-angle head is free to swivel for an angle horizontally. Hence it is called the floating right-angle head. These features are designed to clamp workpieces of different sizes against the side-plates at a two dimensional 90-degree relationship (X and Y axes).

The floating right-angle head is equipped with two tooling holes, one on each clamping surface. Inserts like leveling pads can be inserted with adjustable protrusion so that the workpieces can be clamped with desirable working clearance from the floating right-angle head to make enough room for welding or other work process on the workpieces.

The outside walls of the two side-plates are machined flat and square so that the angle clamp can be laid sideway, or used in an upright position to hold a workpiece perpendicular to the surface of the work desk without the help of a fixture or mounting screws.

A Z-axis attachment can be mounted by screws to the two side-plates accurately and securely. This Z-axis attachment comprises two side-plate extensions joined at one side at 90-degree relationship, a swing away clamping arm with quick release mechanism at the free end, a threaded shaft fed through the quick release mechanism and a clamping head pivoted to the inner end of the threaded shaft. The threaded shaft is positioned along the same direction as the one mounted on the bottom-plate when the clamping arm is at its clamping position. By turning this threaded shaft inward, a third workpiece can be clamped against the comer of the two side-plate extensions of the Z-axis attachment at a position perpendicular to the bottom-plate. As a result, three workpieces can be clamped in three dimensional relationship along three mutually perpendicular directions (X, Y and Z axes) with the setup of one clamping device. In welding applications, the Z-axis attachment is also needed to hold the third welded part securely in place, and to counteract the contraction force induced by a cooling weld.

The assembled workpiece, which may be very bulky, can be removed easily with the clamping arm of the Z-axis attachment swung away to one side of the angle clamp.

The two quick release mechanisms, one mounted on the bottom-plate and the other mounted at the free end of the clamping arm of the Z-axis attachment, are provided for feeding the corresponding threaded shaft. Each quick release mechanism consists of a spring-loaded half-threaded nut connected to a quick acting button. When the quick acting button is pressed, the threaded surface of the half-threaded nut is pushed away from the surface of the threaded shaft. The threaded shaft, and hence the clamping head can be pushed in or pulled out rapidly through the nut with the desirable distance. The screwing action is resumed when the quick acting button is released.

### BRIEF DESCRIPTION OF THE DRAWINGS

FIG. 1 is a perspective view of the angle clamp without the Z-axis attachment.

FIG. 2 is a perspective exploded view of the quick release mechanism mounted on the bottom-plate.

FIG. 3 is a perspective view of the angle clamp with leveling pads attached to the floating right-angle head clamping workpieces along X and Y directions.

FIG. 4 is a perspective view of the angle clamp resting vertically on a work bench holding a cylindrical workpiece at the upright position.

FIG. 5 is a perspective view of the angle clamp with the Z-axis attachment's swing away clamping arm in the open position.

FIG. 6 is a perspective view of the angle clamp with the Z-axis attachment clamping workpieces along X, Y and Z directions.

### DETAILED DESCRIPTION OF THE INVENTION

With the help of the drawings and the detail description below, the features of the present invention will be apparent and fully understandable.

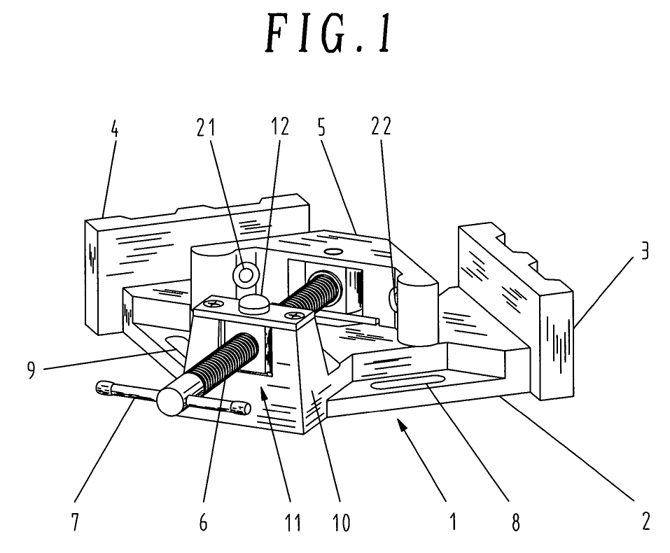

Referring to FIG. 1, the angle clamp 1 comprises three mutually perpendicular base plates, a square shape bottom-plate 2, two rectangular side-plates 3 and 4, and a floating right-angle head 5 attached to a threaded shaft 6 with handle 7. The two side-plates 3 and 4 are located at two adjacent edges of the square shape bottom-plate 2 so that both are perpendicular to the bottom-plate 2 and at right angle to each other. Two slotted holes 8 and 9 are provided along the other two adjacent edges of bottom-plate 2 for accepting screws to fix the angle clamp 1 to a work desk. At the vertex of these two adjacent edges, a vertical ear 10 is equipped at 135 degrees to these edges for feeding the threaded shaft 6. Threaded shaft 6 is fed through a quick release mechanism 11 pivoted at the upper center of ear 10 in a normal direction at 45 degrees to the edges and pointing to the opposite vertex of the bottom-plate 2. The threaded shaft 6 can be swung horizontally with the quick release mechanism 11 at a certain angle away from the normal 45-degree direction for better clamping of workpieces of different shape and sizes. Floating right-angle head 5 is pivoted to the inner end of the threaded shaft 6 and rests on the flat surface of the bottom-plate 2. Floating right-angle head 5 is free to swivel horizontally and to slide on the flat surface of bottom-plate 2 for better clamping of workpieces. Two workpieces can be clamped at right-angle to each other between the right-angle head 5 and the inside surfaces of the two side-plates 3 and 4 along two mutually perpendicular axes, say X and Y axes. To the outside end of the threaded shaft 6, a handle 7 is attached for turning the shaft 6 clockwise or counterclockwise.

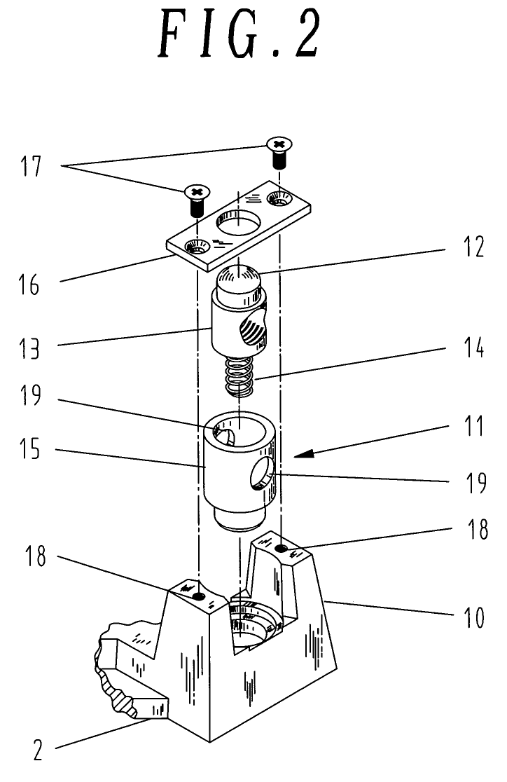

Referring to FIG. 1 and FIG. 2, quick release mechanism 11 with quick acting button 12 is built into ear 10. Instead of moving slowly pitch by pitch by turning the threaded shaft 6, the right-angle head 5 can be moved forward or backward quickly with handle 7 by pressing the quick acting button 12 to release the engagement of the threaded shaft 6 with the half-threaded nut 13. FIG. 2 shows the internal construction of the quick release mechanism 11 in detail. It comprises the quick acting button 12 with half-threaded nut 13, helical spring 14, sleeve 15, cover plate 16 and two screws 17. Quick acting button 12 is actually part of the half-threaded nut 13 which is threaded on the lower surface of the hole for feeding the threaded shaft 6. It is inserted into the center of the sleeve 15 with helical spring 14 in between. Two holes 19 just big enough to feed threaded shaft 6 freely are equipped on both sides of the sleeve 15. Sleeve 15 is inserted onto a recess area at the bottom of ear 10 so that it is free to rotate about its vertical axis. Quick acting button 12, half-threaded nut 13, helical spring 14 and sleeve 15 are retained in position by cover plate 16 and two screws 17 which are screwed into holes 18 on the top surface of ear 10. Threaded shaft 6 is fed through holes 19 and half-threaded nut 13. In normal position, threaded shaft 6 is engaged with the thread inside the hole of half-threaded nut 13. When the quick acting button 12 is pressed, the thread of half-threaded nut 13 is disengaged from threaded shaft 6 so that shaft 6 is free to slide inside nut 13, hence the floating right-angle head 5 is free to slide over the surface of the bottom-plate 2 for quick and easy clamping and releasing of the workpieces.

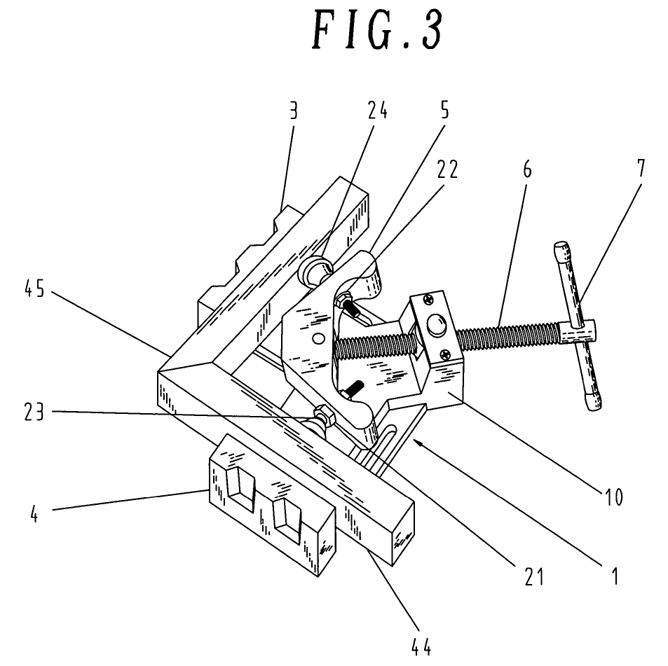

FIG. 3 shows two workpieces 44 and 45 clamped in place along the X and Y axes. Two tooling holes 21 and 22 are equipped in the floating right-angle head 5, one on each clamping surface. Leveling pads 23 and 24 are inserted to the tooling holes 21 and 22 respectively and locked in position by nuts. With the leveling pads 23 and 24 in place, clearance between the workpieces and the floating right-angle head 5 is provided for increased welding access. The screw and nut design of the leveling pads 23 and 24 enables the adjustment for the required clearance.

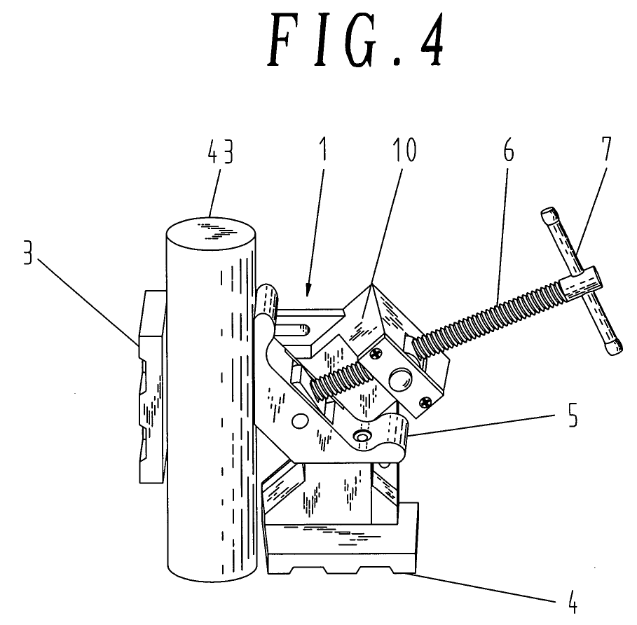

With reference to FIG. 3 and FIG. 4, the outside surfaces of side-plates 3 and 4 are machined flat and square. Hence the angle clamp can be laid vertically with either the outside surface of side-plates 3 or the outside surface of side-plate 4 rest on the work desk to clamp a workpiece perpendicular to the surface of a work desk without the aid of other fixture or device. FIG. 4 shows the angle clamp 1 resting vertically with the outside surface of side-plate 4 on a work desk. The floating right-angle head 5 is clamping a cylindrical workpiece 43 to the inside surface of the side-plate 3 but vertically to the surface of the work desk.

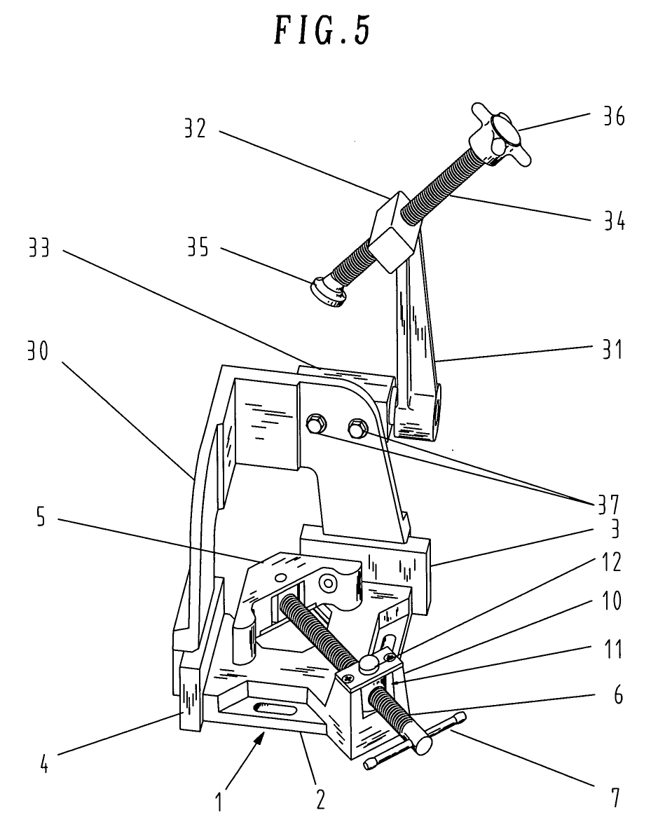

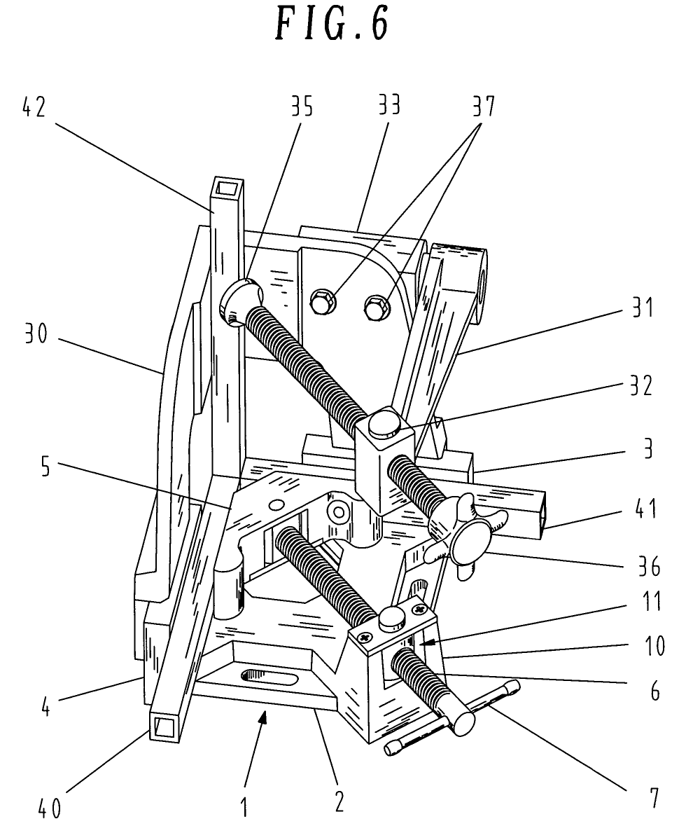

Referring to FIG. 5 and FIG. 6, the Z-axis attachment comprises a right-angle metal plate 30, a clamping arm 31 with quick release mechanism 32, a mounting block 33 and a threaded shaft 34 with clamping pad 35 and turning knob 36. The right-angle metal plate 30 is mounted by screws to the two side-plates 3 and 4 and acts as an extension of the side-plates 3 and 4. The inside surfaces of the metal plate 30 is machined square and flat and made to be align with the inside surfaces of side-plates 3 and 4 so that workpieces 40, 41 and 42 can be clamped at a three dimensional mutually perpendicular relationship (along X, Y and Z axes). Two holes are provided on one side of the metal plate 30 to attach the clamping arm 31 through mounting block 33 with two screws 37. Clamping arm 31 is mounted to the mounting block 33 through a shaft inserted into mounting block 33 so that the clamping arm can be rotated about the axis of the shaft for an angle of approximately 135 degrees. This design enables the clamping arm 31 to be swung away from its clamping position to the open position for rapid and easy removal of the bulky finished workpiece. At the free end of the clamping arm 31, a quick release mechanism 32 is built into the rectangular shape block. This quick release mechanism 32, which is similar in design as the quick release mechanism 11 mounted in the ear 10 of the bottom-plate 2, comprises a quick acting button with half-threaded nut and a helical spring. Threaded shaft 34 is screwed into the half-threaded nut of the quick release mechanism 32. Clamping pad 35 is pivoted to the inside end of threaded shaft 34, and to the outside end a turning knob 36 is attached. This threaded shaft 34 is used to clamp a workpiece against the inside surfaces of the right-angle metal plate 30 along the Z-axis direction. FIG. 6 shows an example of clamping three workpieces along X, Y and Z axes at mutually perpendicular relationship. When the quick acting button is pressed, the half-threaded nut is disengaged from the threaded shaft 34 and the threaded shaft 34 can be pushed in or pulled out rapidly to adjust for workpieces of different thicknesses when clamping, or to remove the finished workpiece when releasing.

What I claim as my invention is:

1. An angle clamp with Z-axis attachment and quick acting button comprising:
three mutually perpendicular base plates, a square shape bottom-plate and two rectangular side-plates which are attached to two adjacent edges of the said square shape bottom-plate so that both are perpendicular to the said square shape bottom-plate and at right angle to each other;
a floating right-angle head attached to a threaded shaft with handle which is fed through a quick release mechanism located at the vertex of the said square shape bottom-plate opposite to the other vertex where the two said rectangular side-plates will meet if extended;
a Z-axis attachment including a right-angle metal plate, a mounting block and a clamping arm with another quick release mechanism and a threaded shaft with clamping pad;
a quick acting button accessible from outside each said quick release mechanism being used to control the locking and releasing action of each said quick release mechanism over each said threaded shaft.

2. An angle clamp with Z-axis attachment and quick acting button according to claim 1, wherein said square shape bottom-plate is equipped with two slotted holes along two adjacent edges other than the two edges attaching to the two said rectangular side-plates so that the said angle clamp assembly can be fixed to a work desk by screws.

3. The floating right-angle head according to claim 1 is free to swivel horizontally and to slide freely on the flat surface of the said square shape bottom-plate with the attached threaded shaft;
the said threaded shaft, when turned clockwise by the said handle, will advance the said floating right-angle head towards the said rectangular side-plates so that two workpieces can be clamped at right-angle to each other against the inside surfaces of the said side-plates;
the said threaded shaft, when turned counterclockwise by the said handle, will retract the said floating right-angle head away from the said rectangular side-plates so that the clamped workpieces can be released.

4. The floating right-angle head according to claim 3, wherein two tooling holes are provided on each clamping surface for inserting the leveling pads, screw threads are made on the internal surfaces of the said tooling holes.

5. The leveling pads according to claim 4, wherein screw threads and locking nuts are equipped to adjust the amount of protrusion of the said leveling pads so that the adjustable clearance between the workpieces and the said floating right-angle head is provided for increased welding access.

6. The two rectangular side-plates according to claim 1, wherein the outside surfaces are machined flat and square so that the said angle clamp assembly can be laid vertically with the outside surface of either one of the said rectangular side-plates resting on the work desk to clamp a workpiece perpendicular to the work desk without the aid of other fixture or device.

7. The Z-axis attachment according to claim 1 comprising a right-angle metal plate, a clamping arm with quick release mechanism, a mounting block and a threaded shaft with clamping pad and turning knob, wherein:
the said right-angle metal plate is mounted by screws to the two said side-plates and act as an extension of the side-plates;
the inside surfaces of the said right-angle metal plate is machined square and flat and made to be align with the inside surfaces of the two said side-plates so that workpieces can be clamped at a three dimensional mutually perpendicular relationship;
the clamping arm is attached externally by screws through the said mounting block to one side of the said right-angle metal plate;
the threaded shaft is fed through the free end of the said clamping arm where another one of the two quick release mechanisms is located.

8. The Z-axis attachment according to claim 7, wherein the said clamping arm is attached to the said mounting block through a shaft inserted to the said mounting block so that the said clamping arm can be rotated about the axis of the shaft for an angle of approximately 135 degrees;
the said clamping arm can thus be swung away from its clamping position to the open position for rapid and easy removal of the bulky finished workpiece.

9. Both the quick release mechanisms according to claim 1 comprising:
a cylindrical shape quick acting button;
a half-threaded nut attached to the internal flat surface of the said quick acting button with the axis of the threaded hole at right angle to the axis of the said quick acting button, wherein the screw thread is made internally on the half side which is opposite to the side closer to the said quick acting button;
a helical spring is placed and partially compressed between the said half-threaded nut and the inside wall of a sleeve or the cavity which holds the said quick release mechanism;
one of the said cavity is located at one of the vertex of the said square bottom-plate and another one of the said cavity is located at the free end of the said clamping arm of the said Z-axis attachment.

10. Both the quick acting buttons of claim 9, when pressed by one's finger, will push the said half-threaded nut to compress the said helical spring and the said internal screw thread to disengage from the threaded shaft fed through the said half-threaded nut so that the said threaded shaft can be moved freely through the threaded hole of the said half-threaded nut instead of moving pitch by pitch with the turning of the said threaded shaft;
when the quick acting button of claim 9 is released, the said half-threaded nut is pushed back by the said helical spring so that the said internal screw thread is engaged with the said threaded shaft and return to the pitch by pitch movement.
